(19) United States
(12) Patent Application Publication
(10) Pub. No.: US 2008/0228571 A1
(43) Pub. Date: Sep. 18, 2008

(54) Automated recommendation of targeting criteria

(76) Inventor: Joshua M. Koran, Mountain View, CA (US)

Correspondence Address: STATTLER - SUH PC, 60 SOUTH MARKET STREET, SUITE 480, SAN JOSE, CA, 95113, US

(21) Appl. No.: 11/725,020

(22) Filed: Mar. 16, 2007

(51) Int. Cl. G06Q 30/00

(52) U.S. Cl. 705/14

(57) ABSTRACT

A system and method to facilitate automated recommendation of targeting criteria are described. Targeting data associated with an advertiser entity and one or more competitor entities of the advertiser entity within a specified industry is retrieved. A set of criteria to target advertisements to a plurality of consumers of the advertiser entity based on the retrieved targeting data is further determined. Finally, presentation of the advertisements to the targeted consumers is facilitated based on the selected set of criteria.

### TECHNICAL FIELD

The present invention relates generally to computer applications and, more particularly, to a system and method to facilitate recommendation of criteria to target advertisements to specific visitors/consumers.

### BACKGROUND OF THE INVENTION

Marketing is the art of reaching the right consumer or consumer, with the right message at the right time. Since marketers cannot afford to craft unique messages for each targeted individual, they always deal with large segments of their target market at any given time.

An efficient system of targeting advertisements can improve a marketer's return on the advertising budget. However, the learning curve in determining such targeting parameters for any given product or brand is expensive and time consuming.

Thus, what is needed is a system and method to provide recommendations of targeting criteria in order to improve the overall effectiveness of the advertisements.

### SUMMARY OF THE INVENTION

A system and method to facilitate automated recommendation of targeting criteria are described. Targeting data associated with an advertiser entity and one or more competitor entities of the advertiser entity within a specified industry is retrieved. A set of criteria to target advertisements to a plurality of consumers of the advertiser entity based on the retrieved targeting data is further determined. Finally, presentation of the advertisements to the targeted consumers is facilitated based on the selected set of criteria.

### BRIEF DESCRIPTION OF THE DRAWINGS

The present invention is illustrated by way of example and not intended to be limited by the figures of the accompanying drawings in which like references indicate similar elements and in which:

FIG. 1 is a flow diagram illustrating a processing sequence to facilitate automated recommendation of targeting criteria and presentation of advertisements to consumers, according to one embodiment of the invention;

FIG. 2 is a block diagram illustrating an exemplary entity containing a system to facilitate automated recommendation of targeting criteria and presentation of advertisements to consumers, according to one embodiment of the invention;

FIG. 3 is a flow diagram illustrating a method to identify targeting data, according to one embodiment of the invention;

FIG. 4 is a flow diagram illustrating a method to select a set of optimized criteria to target advertisements to specific consumers, according to one embodiment of the invention;

FIG. 5 is a flow diagram illustrating a method to facilitate presentation of advertisements to consumers based on the selected optimized criteria, according to one embodiment of the invention;

FIG. 6 is a flow diagram illustrating a method to facilitate automatic presentation of advertisements to consumers based on the selected optimized criteria, according to one embodiment of the invention;

FIG. 7 is a diagrammatic representation of a machine in the exemplary form of a computer system within which a set of instructions may be executed.

### DETAILED DESCRIPTION

A system and method to facilitate automated recommendation of targeting criteria are described. The system determines a competitive set of advertisers for an advertiser entity and uses the collective experience of that competitive set, including, for example, historical consumer targeting information, to improve the overall effectiveness of the presentation of advertisements to consumers.

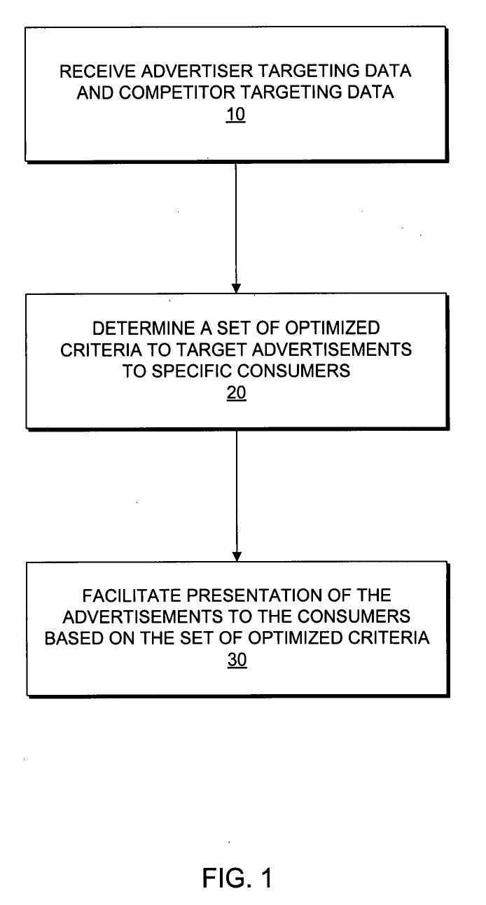

FIG. 1 is a flow diagram illustrating a processing sequence to facilitate automated recommendation of targeting criteria and presentation of advertisements to consumers. As shown in FIG. 1, at processing block 10, the sequence starts with retrieval of targeting data associated with an advertiser entity and targeting data associated with corresponding competitors of the advertiser entity within a specific industry. In one embodiment, the user or advertiser connects to an entity, which contains a system to facilitate automated recommendation of targeting criteria and presentation of advertisements to visitors/consumers of the entity, and transmits a request to determine targeting criteria, as described in further detail below. Alternatively, the advertiser may connect to the entity via a network to transmit the request to display the targeting criteria. In response to the request, the entity retrieves targeting data associated with the advertiser and its identified competitors, respectively, such as, for example, historical targeting information for the advertiser and its competitors.

Next, at processing block 20, a set of optimized criteria to target advertisements to specific consumers are determined. In one embodiment, the entity receives the request and optimizes the respective targeting data to determine one or more targeting criteria for subsequent presentation of advertisements, as described in further detail below.

Finally, at processing block 30, presentation of the advertisements to the consumers is facilitated based on the set of optimized criteria. In one embodiment, the entity displays the set of optimized targeting criteria to the advertiser and the advertiser further instructs the entity to present predetermined advertisements to the consumers with attributes matching to the selected targeting criteria, as described in further detail below. Alternatively, the entity generates automatically a selection of advertisements based on the targeting criteria and presents the advertisements to the specific consumers, as described in detail below.

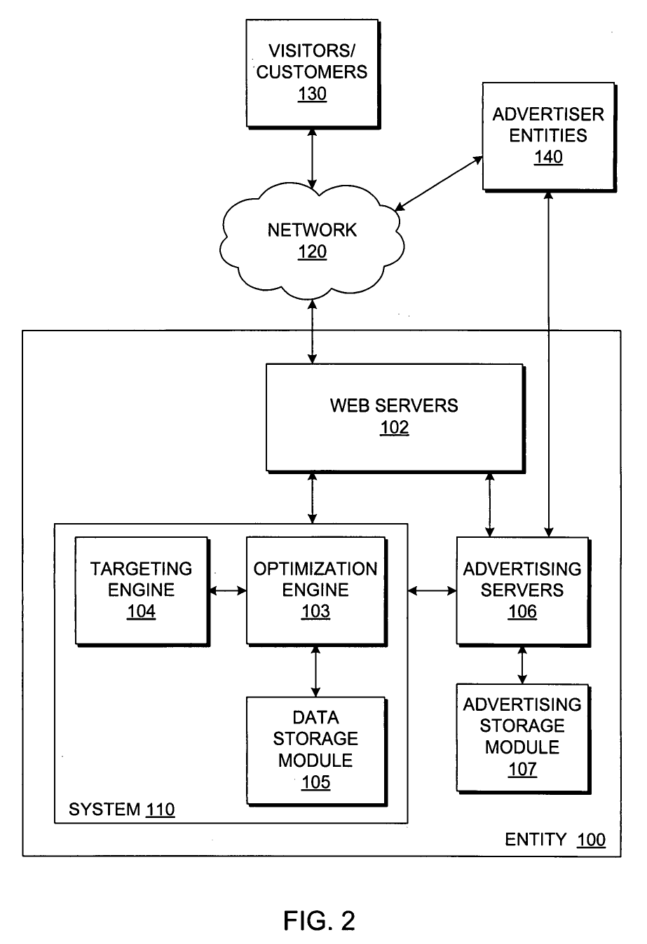

FIG. 2 is a block diagram illustrating an exemplary entity containing a system to facilitate automated recommendation of targeting criteria and presentation of advertisements to consumers. While an exemplary embodiment of the present invention is described within the context of an entity 100 enabling such recommendation and presentation operations, it will be appreciated by those skilled in the art that the invention will find application in many different types of computer-based, and network-based, entities.

In one embodiment, the entity 100, such as, for example, an Internet portal, includes one or more front-end web servers 102, which may, for example, deliver web pages to multiple visitors or consumers 130, (e.g., markup language documents), handle search requests to the entity 100, provide automated communications to/from visitors/consumers 130 of the entity 100, deliver images to be displayed within the web pages, deliver content information to the visitors/consumers 130, and other interface operations in connection with the visitors/consumers 130. In one embodiment, the front-end web servers 102 are further configured to provide interface capabilities to one or more users 140, such as, for example, advertisers, marketers, or other users of applications residing within the entity 100, and to enable such users 140 to communicate with the entity 100, either directly or through a network 120. Alternatively, the entity 100 may include a number of additional front-end servers (not shown), which provide an intelligent interface to the back-end of the entity 100.

In one embodiment, the entity 100 further includes one or more back-end servers coupled to the front-end web servers 102, such as, for example, advertising servers 106, and other processing servers, such as, for example, database processing servers (not shown), and a system 110 to facilitate automated recommendation of targeting criteria and presentation of advertisements, as described in further detail below, the system 110 being coupled to the front-end web servers 102 and the advertising servers 106.

In one embodiment, the system 110 further includes an optimization engine 103 coupled to a data storage module 105 and a targeting engine 104 coupled to the optimization engine 103. The optimization engine 103 may include software and/or hardware modules configured to perform recommendation and presentation operations, as described in further detail below. The targeting engine 104 may include software and/or hardware modules configured to perform automated targeting of advertisements, as described in detail below.

The data storage module 105, which at least partially implements and supports the system 110, may include one or more storage facilities, such as a database or collection of databases, which may be implemented as relational databases. Alternatively, the data storage module 105 may be implemented as a collection of objects in an object-oriented database, as a distributed database, or any other such databases. The data storage module 105 is accessible by the optimization engine 103 and stores targeting data, as described in further detail below.

In one embodiment, the visitors/consumers 130 and the users/advertisers 140 may access the entity 100 through a client machine (not shown) coupled to the visitors/consumers 130 and the users/advertisers 140 or, in the alternative, through a client program, such as a browser (e.g., the Internet Explorer browser distributed by Microsoft Corporation of Redmond, Wash.), that executes on the client machine and accesses the facility 100 via the network 120, such as, for example, the Internet. Other examples of networks that a client may utilize to access the entity 100 includes a wide area network (WAN), a local area network (LAN), a wireless network (e.g., a cellular network), the Plain Old Telephone Service (POTS) network, or other known networks.

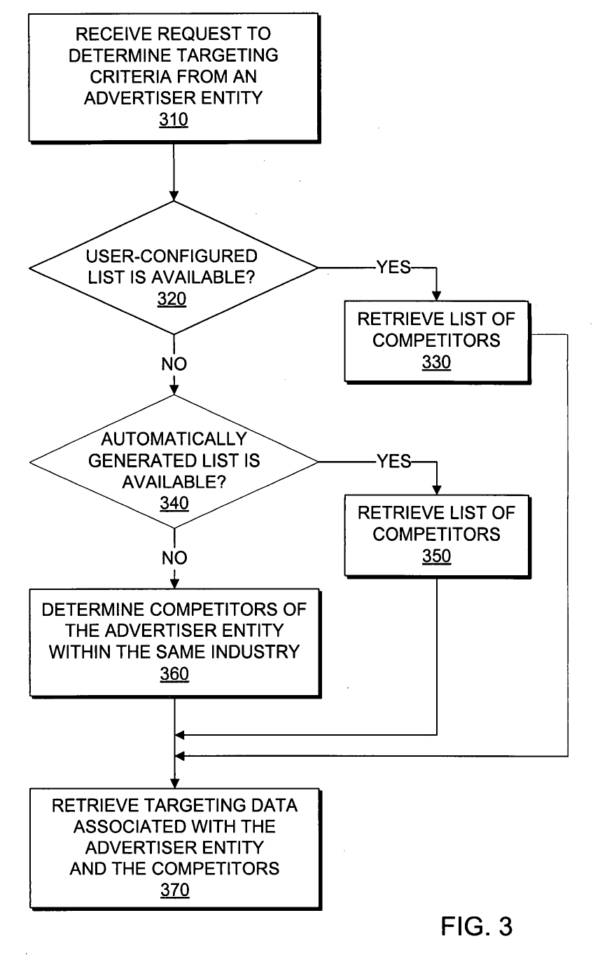

FIG. 3 is a flow diagram illustrating a method to identify targeting data, as presented at processing block 10 of FIG. 2. As shown in FIG. 3, at processing block 310, a request to determine a set of criteria to target advertisements to specific consumers is received. In one embodiment, a user, such as, for example, the advertiser entity 140, connects directly to the advertising servers 106 within the entity 100 and transmits a request to determine the targeting criteria and to receive recommendations of criteria necessary to accomplish specific advertising goals, such as, for example, acquisition, branding, direct response, retention, and/or monetization. Alternatively, the advertiser 140 may connect to the web servers 102 within the entity 100 via the network 120 to transmit the request to determine the targeting criteria.

At processing block 320, a decision is made whether a user-configured list of competitors is available. In one embodiment, the entity 100 determines whether a list containing the advertiser's competitors is stored within the data storage module 105 or, in the alternative, the advertising storage module 107, the list being assembled or configured by the advertiser 140 and subsequently stored within the respective storage module 105, 107. If a user-configured list is available, then, at processing block 330, the entity 100 retrieves the user-configured list of competitors from the appropriate storage module.

Otherwise, at processing block 340, a decision is made whether an automatically-generated list of competitors is available. In one embodiment, the entity 100 determines whether the automatically-generated list of competitors is stored within the data storage module 105 or, in the alternative, the advertising storage module 107. In one embodiment, the list of competitors is generated automatically by search-click stream analysis, whereby all click events performed by visitors/consumers of the entity 100 on multiple result-set links associated with a single search event on a single keyword/concept are considered link competitors and are further aggregated and stored to create competitor lists. Alternatively, the list of competitors may be generated automatically within the entity 100 and stored within a respective storage module through any event monitoring method configured to identify an advertiser's competitors within a specific industry.

If an automatically-configured list is available, then, at processing block 350, the entity 100 retrieves the list of competitors from the appropriate storage module. Otherwise, at processing block 360, competitors of the advertiser 140 are identified. In one embodiment, the entity 100 accesses available industry data over the network 120, such as, for example, Dunn & Bradstreet published data, and identifies a list of competitors for the advertiser 140.

Finally, at processing block 370, targeting data associated with the user/advertiser 140 and its competitors is retrieved. In one embodiment, the entity 100 retrieves past targeting data related to advertising information associated with the user/advertiser 140 and its respective identified competitors from the data storage module 105 and/or the advertising storage module 107.

In one embodiment, past targeting data may include, for example, demographic information, such as gender, age, occupation of targeted visitors/consumers, technographic information, such as the equipment used, the type of client browser and operating system, Internet Protocol address and mapping to geographical information, context information, such as targeting data while visitors/consumers are present on a particular web site, inferred profile information, such as data obtained from a behavioral targeting system, which monitors and registers the activities and behavior of visitors/consumers while accessing various web sites, and timing information, such as the time of day or the day within a week when visitors/consumers respond favorably to the targeted advertisements. The procedure then jumps to processing block 20 shown in connection with FIG. 2.

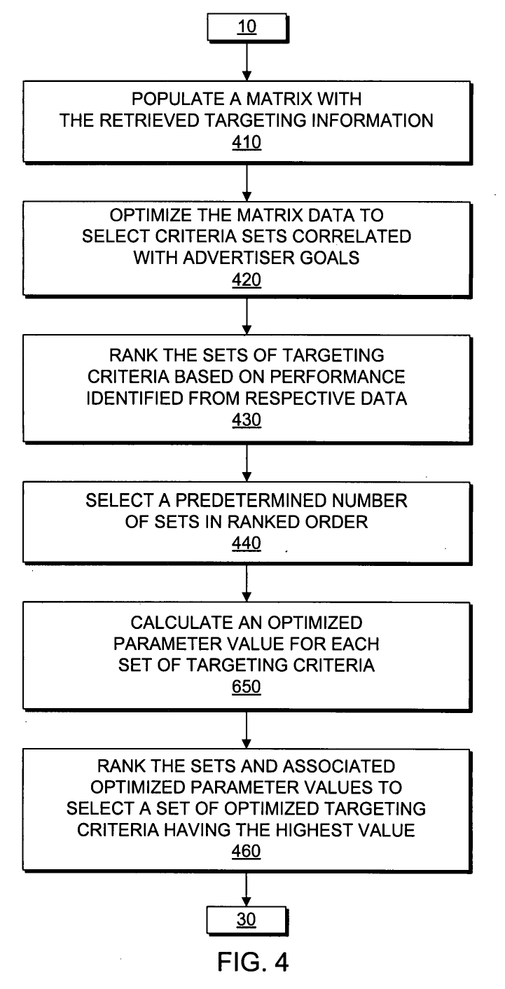

FIG. 4 is a flow diagram illustrating a method to select a set of optimized criteria to target advertisements to specific consumers, as presented at processing block 20 of FIG. 2. As shown in FIG. 4, at processing block 410, a matrix is populated with the retrieved advertiser targeting data and the respective competitor targeting data. In one embodiment, the optimization engine 103 within the entity 100 receives the retrieved targeting data and populates a matrix, such as, for example, a permutation matrix, which contains the user/advertiser information, the visitors/consumers information and the corresponding targeting data.

At processing block 420, sets of targeting criteria highly correlated with the goals of the advertiser entity 140 are selected. In one embodiment, the optimization engine 103 applies one of many known optimization algorithms, such as, for example, a clustering algorithm or a segmentation algorithm, to optimize the matrix and to select the sets of targeting criteria. The targeting criteria may include, for example, demographic criteria, technographic criteria, geographical criteria, contextual criteria, consumer profile criteria, and/or timing criteria, as described in further detail above. In an alternate embodiment, the optimization engine 103 selects the sets of targeting criteria from the entire body of data stored within the matrix.

In one embodiment, if the advertisements are sponsored listings, a matrix of keywords by all advertisers in a competitive set by click-through-rate parameter (CTR) is created. The CTR parameter may include clicks from natural search events, sponsored search events, or a combination of both. The keywords having a highest CTR value and/or a best cost-per-click (CPC)/CTR ratio (e.g., a high ratio like {$2 CPC /1% CTR} is worse than the lower ratio {$1 CPC/1% CTR}) are selected for further recommendation to the advertiser entity 140. Any keywords currently bid on by a specific advertiser entity 140 are marked, such that they can be filtered from any further recommendation.

In an alternate embodiment, if the advertisements are graphical ads part of a graphical ad campaign, the set of advertisements having a minimum number of clicks is used to identify direct-response campaigns. For these campaigns, a matrix of targeting data by all advertisers in a competitive set by the CTR parameter is created. The sets of targeting criteria having a highest CTR value and/or a CTR/CPM ratio are selected for further recommendation to the advertiser entity 140. Any targeting criteria currently purchased by the advertiser entity 140 are marked in order to be filtered from any further recommendation.

In one example, considering a product manufacturer X, such as, for example, an automobile manufacturer, the optimization engine 103 may reduce the dimensionality of the matrix by using the gender information, the age information, the geographical information, and the direct response information retrieved from a behavioral targeting system, all stored within the matrix to obtain a number of sets of targeting criteria, as follows:

a. Female, 35-45 years old;

b. Female, BTS/Direct Response, luxury autos;

c. Female, 18-25 years old, living in the 90210 zip code; etc.

At processing block 430, the sets of targeting criteria are ranked based on performance identified from the respective past targeting data and adapted to the goals of the user/advertiser 140. In one embodiment, the optimization engine 103 ranks the selected criteria sets based on historical performance when presented to targeted visitors/consumers within the network 120.

At processing block 440, a predetermined number of criteria sets are selected. In one embodiment, the optimization engine 103 considers only a predetermined number of highly ranked sets for further processing. In an alternate embodiment, the optimization engine 103 may process all the ranked sets of targeting criteria. In the example detailed above, the optimization engine 103 ranks the sets of targeting criteria and selects the top three sets as follows:

1. Female, 35-45 years old;

2. Female, BTS/Direct Response, luxury autos;

3. Female, 18-25 years old, living in the 90210 zip code.

At processing block 450, an optimized parameter value is calculated for each set of targeting criteria as a function of the associated performance and a cost parameter value. In one embodiment, the optimization engine 103 multiplies the performance parameters retrieved for each set of targeting criteria with a cost parameter value, which represents the amount of money necessary to target the respective set, for example, 35-45 year-old females. Each resulting optimized parameter value is further assigned to the corresponding set of targeting criteria.

At processing block 460, the criteria sets and their respective optimized parameter values are further ranked to select the optimized set of targeting criteria associated with the highest calculated optimized parameter value. In one embodiment, the optimization engine 103 subsequently ranks the sets based on their respective optimized parameter values and selects the optimized set of targeting criteria associated with the highest calculated optimized parameter value. The procedure then jumps to processing block 30 shown in connection with FIG. 2.

In the above example, if the cost parameters and the assigned optimized parameter values are calculated as follows, then the new ranking may be assembled as follows:

1. Female, 35-45 years old, $10.00, optimized value “x”;

2. Female, 18-25 years old, living in the 90210 zip code, $5.00,

3. Female, BTS/Direct Response, luxury autos, $15.00, “y”.

Therefore, the selected highest ranked optimized set of targeting criteria for the automobile manufacturer X is (Female, 35-45 years old).

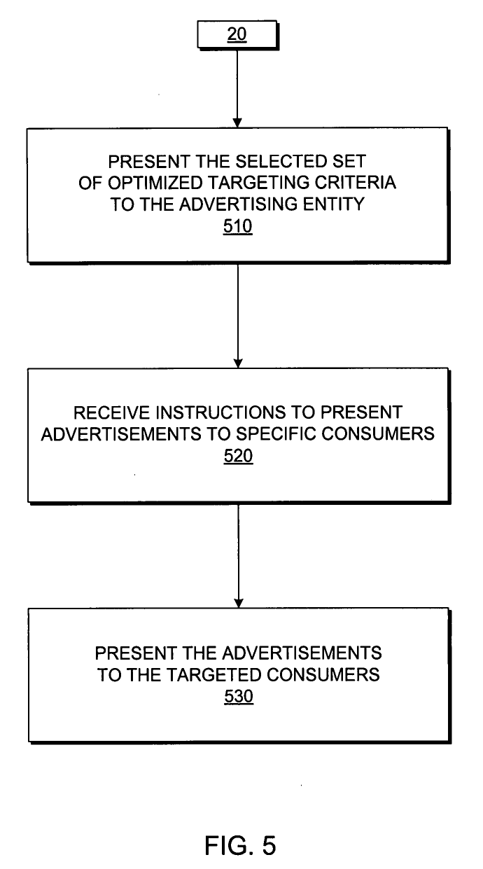

FIG. 5 is a flow diagram illustrating one embodiment of a method to facilitate presentation of advertisements to consumers based on the selected optimized criteria, as presented at processing block 30 of FIG. 2. At processing block 510, the selected set of optimized targeting criteria is presented to the advertiser entity 140. In one embodiment, the optimization engine 103 transmits the set of optimized targeting criteria to the advertiser entity 103 via the web servers 102 and the network 120, or, in the alternative, via the advertising servers 106. In another alternate embodiment, the optimization engine 103 may transmit all the ranked sets of targeting criteria to the advertiser entity 140 with specific recommendations as to the preferred optimized criteria set. The response rates for each set of targeting criteria may be also presented to the advertise entity 140 showing which areas the advertiser 140 is outperforming, matching, or underperforming the response rates of their competitors. The recommendations can thus be presented within a portfolio framework of targeting permutations, in addition of being listed in a ranked order.

At processing block 520, instructions to present advertisements to specific visitors/consumers 130 are received from the advertiser entity 140. In one embodiment, the optimization engine 103 receives instructions from the advertiser entity 140 to present advertisements stored within the advertising storage module 107 to visitors/consumers 130 which fit the set of optimized targeting criteria. Finally, at processing block 530, the optimization engine 103 presents the advertisements to the targeted visitors/consumers 130 based on the received instructions, such as, for example, to females in the 35-45 year-old range.

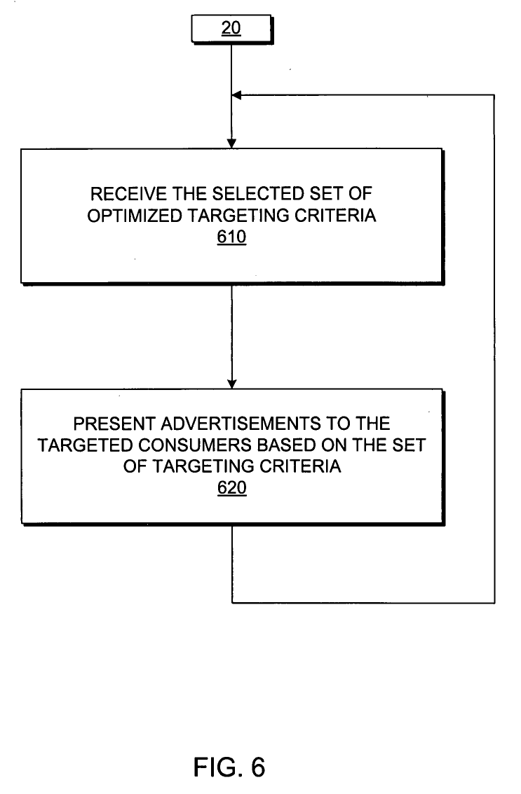

FIG. 6 is a flow diagram illustrating an alternate embodiment of a method to facilitate presentation of advertisements to consumers based on the selected optimized criteria, as presented at processing block 30 of FIG. 2. At processing block 610, the selected set of optimized targeting criteria is presented to the targeting engine 104. In one embodiment, the optimization engine 103 transmits the set of optimized targeting criteria to the targeting engine 104 at predetermined periods of time.

At processing block 620, automatic presentation of advertisements is performed based on the set of optimized targeting criteria. In one embodiment, the targeting engine 104 receives the set of optimized targeting criteria and transmits advertisements stored within the advertising storage module 107 to visitors/consumers 130, which fit the set of optimized targeting criteria. The procedure is subsequently repeated using a predetermined cycle time to update the set of optimized targeting criteria.

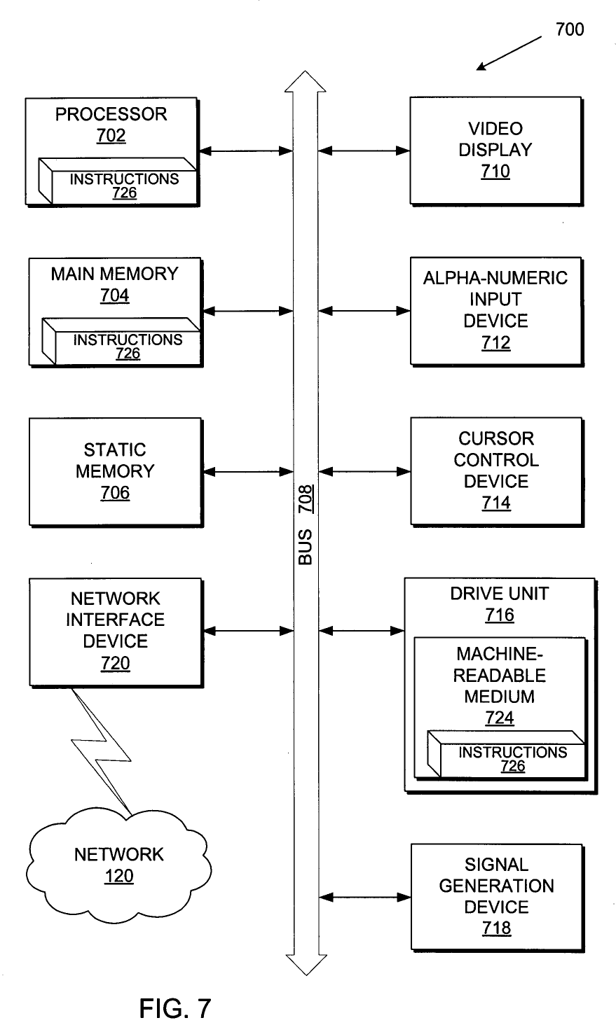

FIG. 7 shows a diagrammatic representation of a machine in the exemplary form of a computer system 700 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 700 includes a processor 702, a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker), and a network interface device 720.

The disk drive unit 716 includes a machine-readable medium 724 on which is stored a set of instructions (i.e., software) 726 embodying any one, or all, of the methodologies described above. The software 726 is also shown to reside, completely or at least partially, within the main memory 704 and/or within the processor 702. The software 726 may further be transmitted or received via the network interface device 720.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method comprising:
retrieving targeting data associated with an advertiser entity and at least one competitor entity of said advertiser entity;
determining a set of criteria to target advertisements to a plurality of consumers based on said retrieved targeting data; and
facilitating presentation of said advertisements to said plurality of consumers based on said set of criteria.

2. The method according to claim 1, wherein said determining further comprises:
populating a matrix with said retrieved targeting data; and
optimizing said matrix data to select a plurality of sets of targeting criteria correlated with advertising goals associated with said advertiser entity.

3. The method according to claim 2, wherein said determining further comprises:
ranking said plurality of sets of targeting criteria based on a performance parameter identified from respective targeting data;
selecting a predetermined number of sets of targeting criteria in ranked order;
calculating an optimized parameter value for each selected set of targeting criteria; and
ranking said predetermined number of sets of targeting criteria and corresponding optimized parameter values to select said set of criteria having the highest optimized parameter value.

4. The method according to claim 1, wherein said facilitating further comprises:
presenting said set of criteria to said advertiser entity;
receiving instructions to present said advertisements based on said set of criteria; and
presenting said advertisements to said consumers based on said received instructions.

5. The method according to claim 1, wherein said facilitating further comprises:
receiving said selected set of criteria; and
automatically presenting said advertisements to said consumers based on said set of criteria.

6. The method according to claim 1, wherein information related to said at least one competitor entity is provided by said advertiser entity.

7. The method according to claim 1, wherein information related to said at least one competitor entity is generated automatically by search click stream analysis, wherein click events performed by consumers on multiple result links associated with a single search event are considered link competitors corresponding to said at least one competitor entity.

8. A computer readable medium containing executable instructions, which, when executed in a processing system, cause said processing system to perform a method comprising:
retrieving targeting data associated with an advertiser entity and at least one competitor entity of said advertiser entity;
determining a set of criteria to target advertisements to a plurality of consumers based on said retrieved targeting data; and
facilitating presentation of said advertisements to said plurality of consumers based on said set of criteria.

9. The computer readable medium according to claim 8, wherein said determining further comprises:
populating a matrix with said retrieved targeting data; and
optimizing said matrix data to select a plurality of sets of targeting criteria correlated with advertising goals associated with said advertiser entity.

10. The computer readable medium according to claim 9, wherein said determining further comprises:
ranking said plurality of sets of targeting criteria based on a performance parameter identified from respective targeting data;
selecting a predetermined number of sets of targeting criteria in ranked order;
calculating an optimized parameter value for each selected set of targeting criteria; and
ranking said predetermined number of sets of targeting criteria and corresponding optimized parameter values to select said set of criteria having the highest optimized parameter value.

11. The computer readable medium according to claim 8, wherein said facilitating further comprises:
presenting said set of criteria to said advertiser entity;
receiving instructions to present said advertisements based on said set of criteria; and
presenting said advertisements to said consumers based on said received instructions.

12. The computer readable medium according to claim 8, wherein said facilitating further comprises:
receiving said selected set of criteria; and
automatically presenting said advertisements to said consumers based on said set of criteria.

13. The computer readable medium according to claim 8, wherein information related to said at least one competitor entity is provided by said advertiser entity.

14. The computer readable medium according to claim 8, wherein information related to said at least one competitor entity is generated automatically by search click stream analysis, wherein click events performed by consumers on multiple result links associated with a single search event are considered link competitors corresponding to said at least one competitor entity.

15. A system comprising:
at least one storage module to store targeting data associated with an advertiser entity and at least one competitor entity of said advertiser entity; and
an optimization engine coupled to said at least one storage module to retrieve said targeting data, to determine a set of criteria to target advertisements to a plurality of consumers based on said retrieved targeting data, and to facilitate presentation of said advertisements to said plurality of consumers based on said set of criteria.

16. The system according to claim 15, wherein said optimization engine further populates a matrix with said retrieved targeting data, and optimizes said matrix data to select a plurality of sets of targeting criteria correlated with advertising goals associated with said advertiser entity.

17. The system according to claim 16, wherein said optimization engine further ranks said plurality of sets of targeting criteria based on a performance parameter identified from respective targeting data, selects a predetermined number of sets of targeting criteria in ranked order, calculates an optimized parameter value for each selected set of targeting criteria, and ranks said predetermined number of sets of targeting criteria and corresponding optimized parameter values to select said set of criteria having the highest optimized parameter value.

18. The system according to claim 15, wherein said optimization engine further presents said set of criteria to said advertiser entity, receives instructions to present said advertisements based on said set of criteria, and presents said advertisements to said consumers based on said received instructions.

19. The system according to claim 15, further comprising a targeting engine coupled to said optimization engine, said targeting engine to receive said selected set of criteria, and to present automatically said advertisements to said consumers based on said set of criteria.

20. The system according to claim 15, wherein information related to said at least one competitor entity is provided by said advertiser entity.

21. The system according to claim 15, wherein information related to said at least one competitor entity is generated automatically by search click stream analysis, wherein click events performed by consumers on multiple result links associated with a single search event are considered link competitors corresponding to said at least one competitor entity.
